(19) United States
(12) Patent Application Publication
(10) Pub. No.: US 2012/0021150 A1
(43) Pub. Date: Jan. 26, 2012

(54) OPTICAL WINDOW ASSEMBLY HAVING LOW BIREFRINGENCE

(76) Inventors: Ulrich Wilhelm Heinz Neukirch, Painted Post, NY (US); Ronald Leroy Stewart, Elmira, NY (US)

(21) Appl. No.: 13/169,589

(22) Filed: Jun. 27, 2011

Related U.S. Application Data
(60) Provisional application No. 61/366,287, filed on Jul. 21, 2010.

(51) Int. Cl. B32B 1/02; B32B 3/24

(52) U.S. Cl. 428/34.4; 428/38; 428/34.1

(57) ABSTRACT

An optical window assembly having a geometry that minimizes net induced birefringence. The optical window assembly comprises a transparent window affixed to a frame at an interface. The window assembly has a geometry such that retardance and stress-induced birefringence in the window are reduced or equal to zero. An opto-electronic device that includes the optical window assembly is also described.

### CROSS REFERENCE TO RELATED APPLICATIONS

This application claims the benefit of priority to U.S. Provisional Patent Application No, 61/366,287, filed on Jul. 21, 2010, the content of which is relied upon and incorporated herein by reference in its entirety.

### BACKGROUND

The disclosure is related to an optical window assembly for opto-electronic devices such as micro-electromechanical systems (MEMS). More particularly, the disclosure relates to optical window assemblies in such devices, wherein the net birefringence of the window is reduced.

Opto-electronic devices such as of digital projectors use 2-dimensional micro-mirror arrays to generate the image. These mirror arrays (Micro-Electro-Mechanical Systems or “MEMS”) are mounted in protective housings having a window that allows light to pass into and out of the housing and to and from the mirrors.

Such windows are typically hermetically sealed into a metal frame and have process- and design-induced mechanical stresses that can translate into significant levels of birefringence in the windows. Due to differences between the thermal expansion of the metal frame and the glass, glass that is hermetically sealed to a metal frame at elevated temperatures will always be under some residual stress at device operating temperatures. Although this effect can be reduced by careful selection of material combinations and optimizing annealing cycles during manufacturing, however, some level of residual stress is unavoidable. In MEMS-based projectors, such stress-induced birefringence of optical components results in a change of polarization. In three-dimensional projection systems, a well defined or pure polarization state of projected light is needed. In such instances, additional components—i.e., re-polarizers—are needed at or near the end of the optical train to clean up or correct the polarization state. The presence of such components results in a loss of intensity of projected light.

### SUMMARY

An optical window assembly having a geometry that minimizes net induced birefringence is provided. The optical window assembly comprises a transparent window affixed to a frame at an interface. The window assembly has a geometry such that retardance and stress-induced birefringence in the window are reduced. An opto-electronic device that includes the optical window assembly is also described.

Accordingly, one aspect of the disclosure is to provide an optical window assembly comprising a window affixed to a frame at an interface. The window has a transparent aperture, and the interface has a geometry such that retardance of the window within the transparent aperture is less than 2 nm.

A second aspect of the disclosure is to provide an optical window assembly. The optical window assembly comprises a circularly symmetric window having a transparent aperture and a frame. The circularly symmetric window is affixed to the frame, and the circularly symmetric window has a retardance of less than 2 nm within the transparent aperture.

A third aspect of the disclosure is to provide an opto-electronic device. The opto-electronic device comprises: a housing; an optical window assembly affixed to the housing so as too define an enclosure; and an optical element disposed within the enclosure. The optical window assembly comprises a window affixed to a frame at an interface. The window has a transparent aperture and the optical element is disposed in the enclosure such that an active portion of the optical element is optically aligned with the transparent aperture. The interface and window have a geometry such that retardance of the window within the transparent aperture is less than 2 nm.

These and other aspects, advantages, and salient features will become apparent from the following detailed description, the accompanying drawings, and the appended claims.

### BRIEF DESCRIPTION OF THE DRAWINGS

FIG. 1a is a schematic top view of a conventional optical window assembly;

FIG. 1b is a schematic cross-sectional view of a conventional optical window assembly;

FIG. 2a is a schematic top view of an optical window assembly disclosed herein;

FIG. 2b is a schematic cross-sectional view of an optical window disclosed herein;

FIG. 2c is a schematic top view of a second optical window assembly disclosed herein;

FIG. 2d is a schematic top view of a third optical window assembly disclosed herein;

FIG. 3 is a schematic cross-sectional view of a device comprising an optical window assembly;

FIG. 4a is an image of birefringence in a rectangular window before annealing;

FIG. 4b is an image of birefringence in a rectangular window after annealing;

FIG. 5 is a plot of temperature as a function of time for an annealing schedule for a window;

FIG. 6a is an image of birefringence in a polygonal “pillow” window before annealing; and

FIG. 6b is an image of birefringence in a polygonal “pillow” window after annealing.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range.

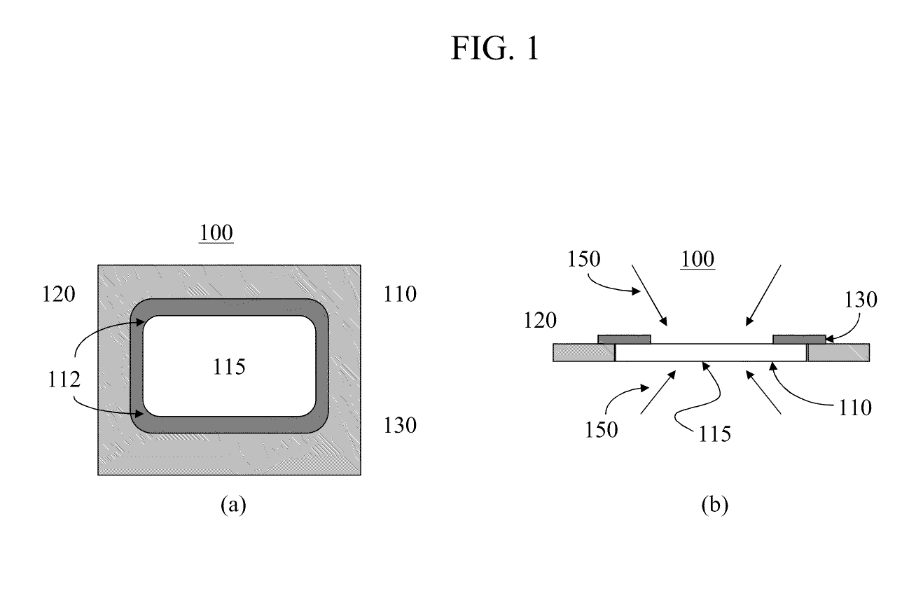

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

As used herein, the term “birefringence,” unless otherwise specified, refers to the splitting experienced by a wavefront when a wave disturbance is propagated in an anisotropic material. The velocity of a wave in anisotropic substances is a function of displacement direction. The term birefringence applies to electromagnetic waves. In materials that exhibit birefringence, either the separation between neighboring atomic structural units is different in different directions, or the bonds tying such units together have different characteristics in different directions. Many crystalline materials, such as calcite, silica (quartz), and topaz, are birefringent.

As used herein, the term “retardance” refers to the phase difference, expressed in nm, between two waves of light traveling through a birefringent material. Incident polarized light having wavelength λ and its electric vector parallel to the slow axis of the material will undergo a retardation δ, expressed in waves, with respect to light polarized parallel to the fast axis of the material. Retardance δ is given by the expression δ=(n_{f}−nₛ)d/λ, where (n_{f}−nₛ) is the birefringence of the material, d is the distance traveled through the birefringent material, and wherein n_{f} and nₛ are the refractive indices along the fast and slow axes, respectively, of the material.

Schematic top and cross-sectional views of a conventional optical window assembly that is currently used in electro-optical devices such as micro-electromechanical systems (MEMS) devices are shown in FIGS. 1a and 1b, respectively. Optical window 100 comprises a transparent window 110 or substrate that is hermetically sealed to a protective metallic housing or frame 120. An opaque coating 130 deposited on either an upper or lower surface of transparent window 110 defines a transparent aperture 115 through which light 150 passes. Light 150 can pass through transparent aperture 115 and strike a mirror or mirror array (not shown) and be reflected back out through aperture 115.

Process- and design-induced mechanical stresses can translate into a considerable amount of birefringence (i.e., equal to a large fraction of the wavelength, or several hundreds of nanometers) in transparent window 110. Residual stress is, for example, generated by hermetically sealing transparent window 110 to frame 120 by heating to elevated temperatures. This stress is caused by differences between the coefficients of thermal expansion of frame 120 and window 110, and can be somewhat mitigated by selection of materials and optimization of annealing cycles after sealing the window or substrate to the housing or frame during manufacturing. In digital light processing applications, current optical windows have a shape and aperture 115 that mirrors the aspect ratios of typical image formats. Consequently, optical mirror 100 has a transparent window 110 that is rectangular in shape with rounded edges or corners 112. The overall rectangular shape and rounded edges or corners 112 of transparent window 110 generate a non-circular symmetric stress—and, therefore, residual birefringence—within transparent window 110.

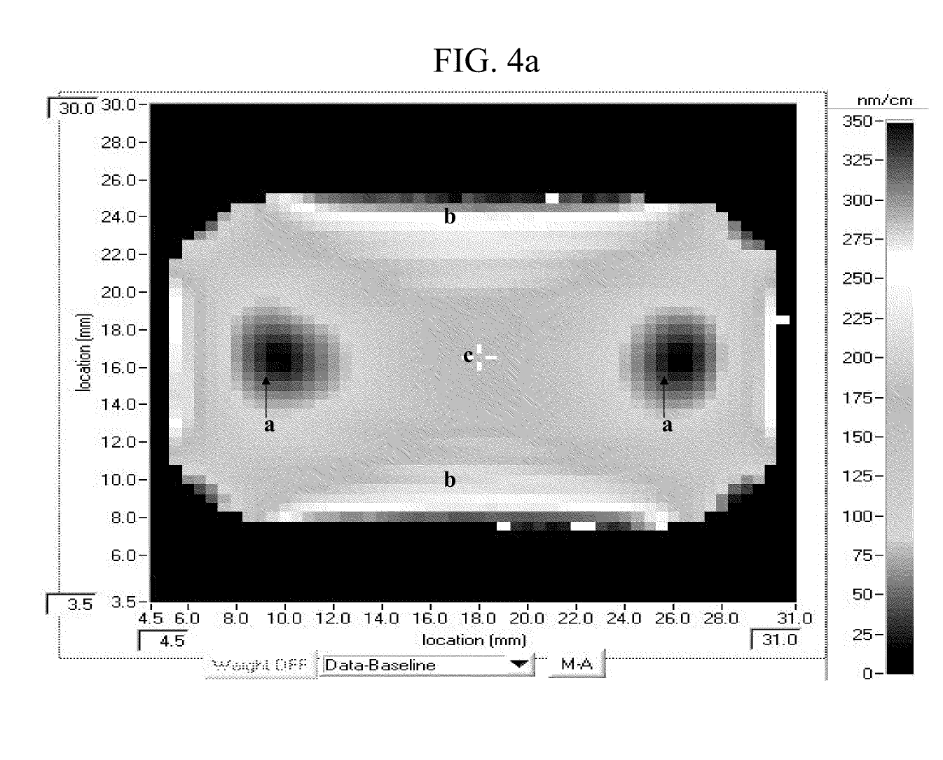

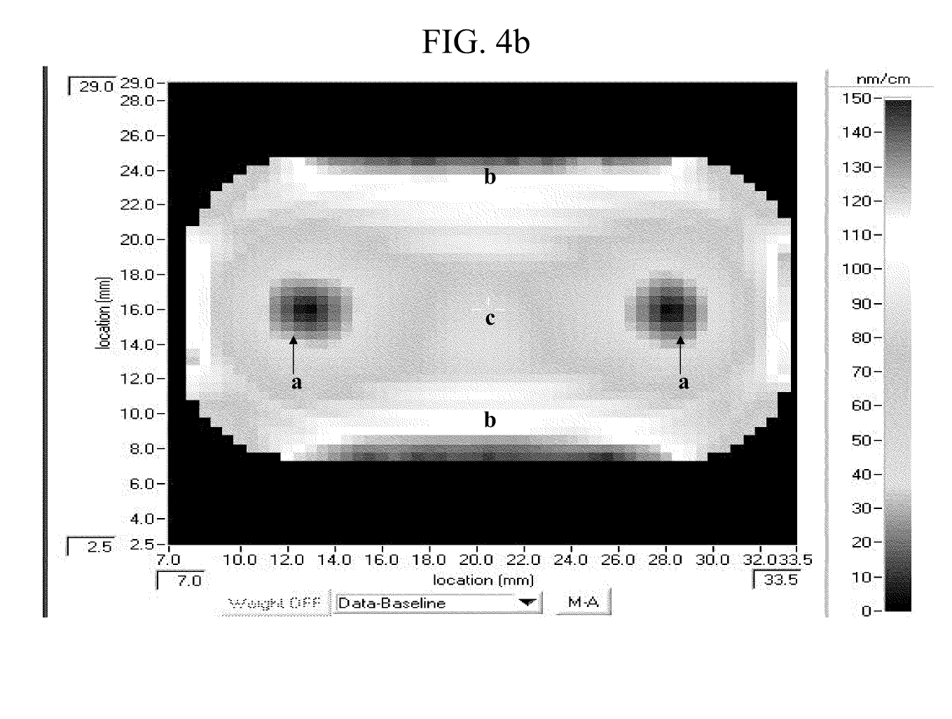

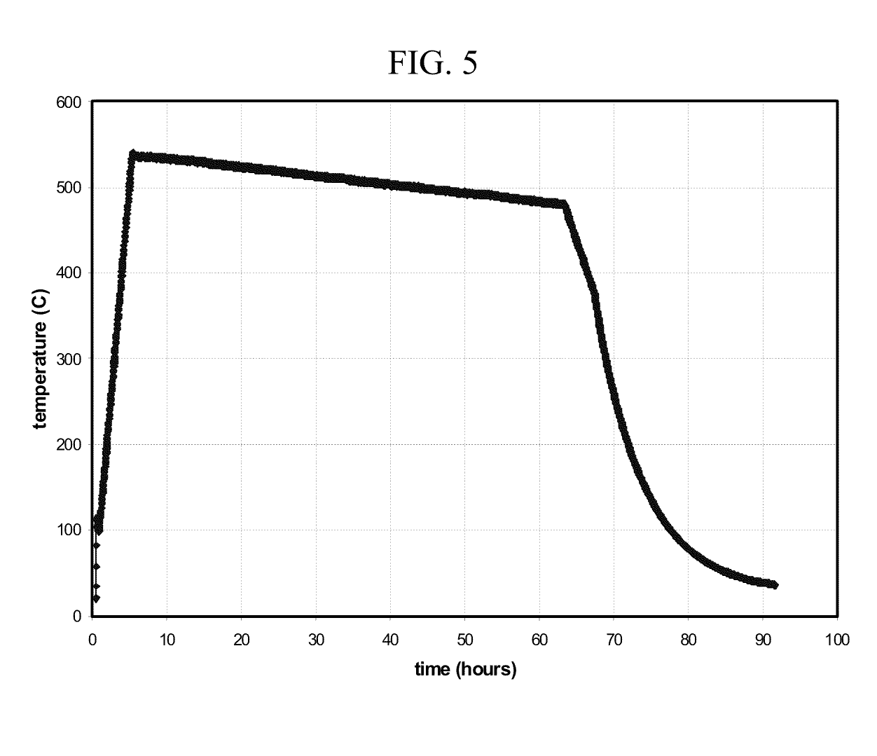

FIGS. 4a and 4b are images of the birefringence in rectangular windows before and after annealing, respectively. Prior to annealing, the window exhibits distinct regions of low (a), high (b), and medium (c) birefringence and an overall pattern of birefringence having a two-fold symmetry. Annealing (FIG. 5) decreases the magnitude of the residual levels and stress and birefringence in the center of the window by about 50%, but does significantly alter the symmetry of the pattern of birefringence.

In projector applications—such as in projectors for polarization-based three-dimensional imaging—the polarization state of light is controlled and maintained throughout the optical train. Presently, birefringence due to the induced stresses described above causes changes in polarization of the light passing through the optical train. Additional components—i.e., re-polarizers—must be positioned at or near the end of the optical train in such projectors to “clean up” or correct the polarization state of light passing through the train. The presence of such components results in a loss of intensity of projected light.

There is provided and described herein an optical window assembly for use in electro-optical devices, such as micro-electromechanical systems (MEMS) devices, in which the retardance and net birefringence of the transparent portion of the window are either reduced to minimum values or to zero. This is achieved by providing the optical assembly with an interface between the window and frame that is either circularly symmetric or near-circularly symmetric. The resulting stress, birefringence, and retardance in the window are symmetric (or nearly symmetric) in all directions. In the case of a circularly symmetric interface and window, birefringence and retardance cancel out over the entire window; i.e., the net values of these parameters equal zero. The circular symmetry also cancels out any stresses that are due to differences in thermal expansion between the metal frame and the glass and constraining of the glass in the frame. In those instances where the interface and window are near-circularly symmetric, stress, birefringence, and retardance may not be entirely canceled out, but are instead reduced to minimum values. The optical window assembly comprises a frame and a window having a transparent aperture, wherein the window is affixed to the frame at an interface. The interface has a geometry such that retardance of the window is less than 2 nm over the area of (i.e., within) the transparent portion of the window, providing the assembly is properly precision annealed using those means known in the art of optical glass. Non-limiting examples of a precision anneal cycle used for a KOVAR™ alkali borosilicate sealing glass 7056, manufactured by Corning, Inc., window and a window and a KOVAR™ iron-nickel-cobalt alloy frame are listed in Table 1, and an anneal cycle (temperature vs. time) for is plotted in FIG. 5. With the exception of the step of heating from ambient temperature (about 25° C.) to 520° C., soak and cooling steps used for annealing the glass window alone and the glass and frame are identical. In some embodiments, net birefringence and/or the retardance δ of the window and/or transparent portion of the window has either a minimum value or is equal to zero.

TABLE 1
Precision anneal schedules for Corning 7650 glass window and 7650 glass window
and KOVAR ™ frame.

| | Corning 7056 glass | | | | 7056 glass and KOVAR frame | | | |
|---|---|---|---|---|---|---|---|---|
| | | | Rate | Time | | | Rate | Time |
| Step | From | To | (° C./hr) | (hr) | From | To | (° C./hr) | (hr) |
| Heat | Ambient | 520° C. | 150 | ~3.3 | Ambient | 520° C. | 100 | ~5.2 |
| Soak | 520° C. | 520° C. | | 3 | 520° C. | 520° C. | | 3 |
| Cool | 520° C. | 465° C. | 1.25 | 44 | 520° C. | 465° C. | 1.25 | 44 |
| Cool | 465° C. | 365° C. | 25 | 44 | 465° C. | 365° C. | 25 | 44 |
| Cool | 365° C. | 100° C. | Furnace | | 365° C. | 100° C. | Furnace | |
| | | | rate^{a} | | | | rate^{a} | |

^{a}Furnace rate is rate of cooling of furnace when power is cut off.

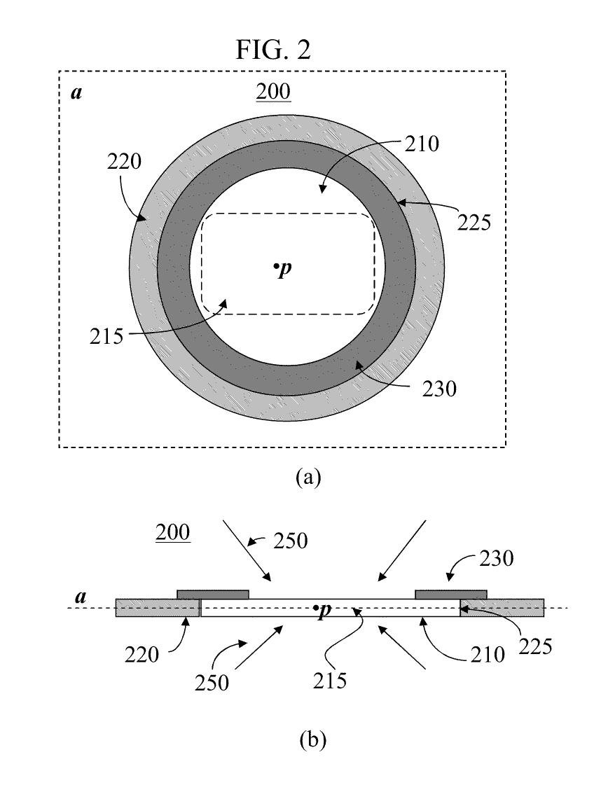

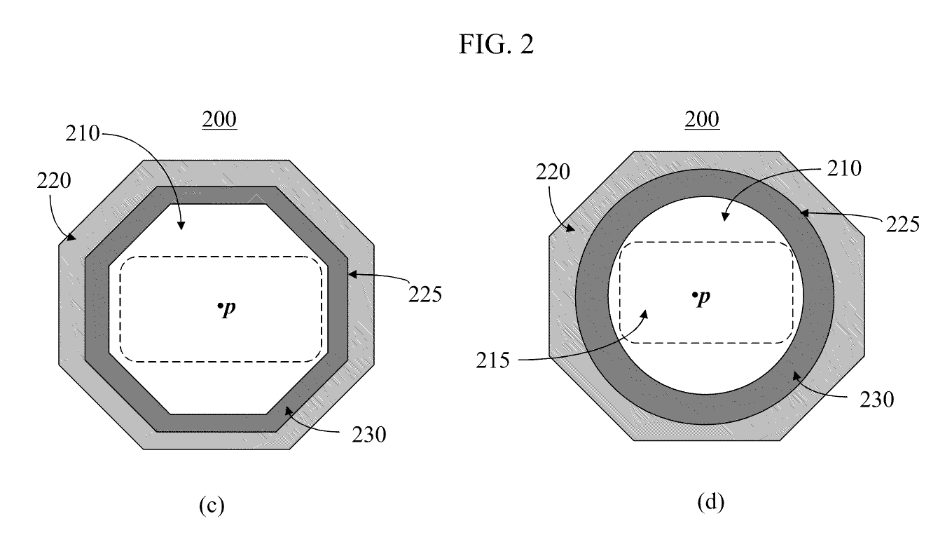

Schematic top and cross-sectional views of the optical window assembly that is described herein are shown in FIGS. 2a and 2b, respectively. Optical window assembly 200 comprises a transparent window 210, which is affixed to a protective housing or frame 220 at interface 225. In the embodiment shown in FIGS. 2a and 2b, the geometry of interface 225 is circularly symmetric about a single point p. The window 210, in most embodiments, has the same geometry as interface 220. The circularly symmetrical geometry of interface 225 and window 210 cancels out the net induced birefringence due to thermal expansion differences (with metal frame 220) that would appear in window 210 to zero and reduces retardance to below 2 nm within transparent aperture 215 of window 210.

While interface 225 and window 210 having a circular symmetry are shown in FIGS. 2a and 2b, interface 225 may also have other geometries/symmetries, so long as such geometries/symmetries reduce retardance in transparent aperture 215 to less than 2 nm or otherwise reduce retardance and net induced birefringence to either a minimum value or to zero. For example, interface 225 and window 210 can have a polygonal symmetry (FIG. 2c) if the retardance of window 210 is less than 2 mm. While interface 225 in FIG. 2c has an eight-fold symmetry, it is understood that other such polygonal symmetries that are capable of reducing the retardance to less than 2 nm are also within the scope of the disclosure.

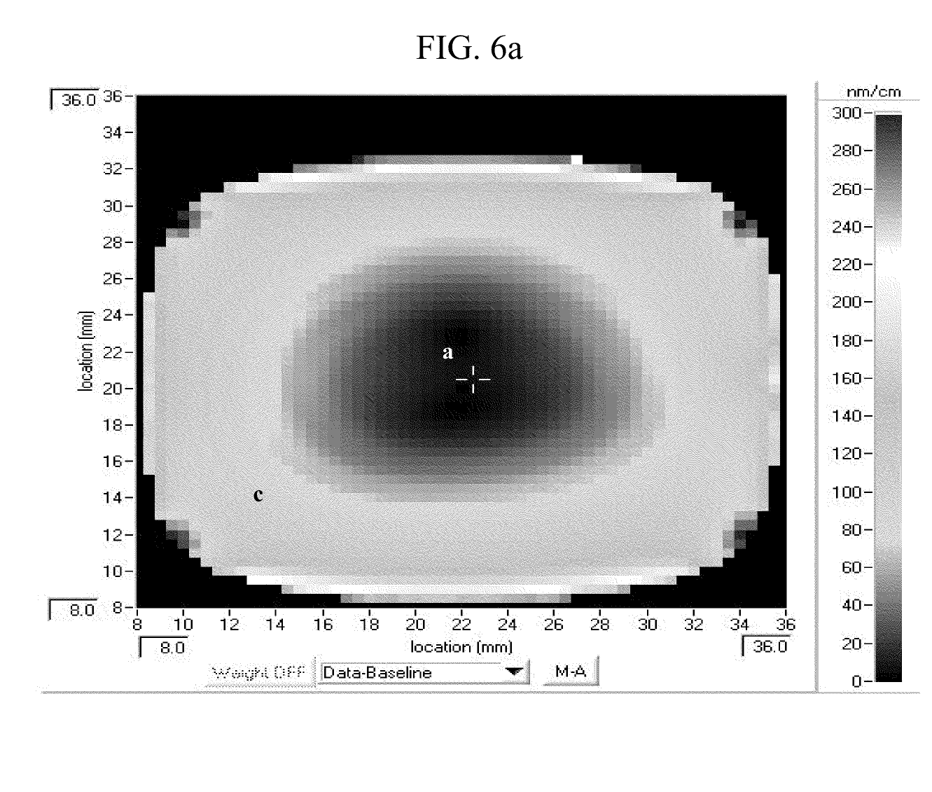

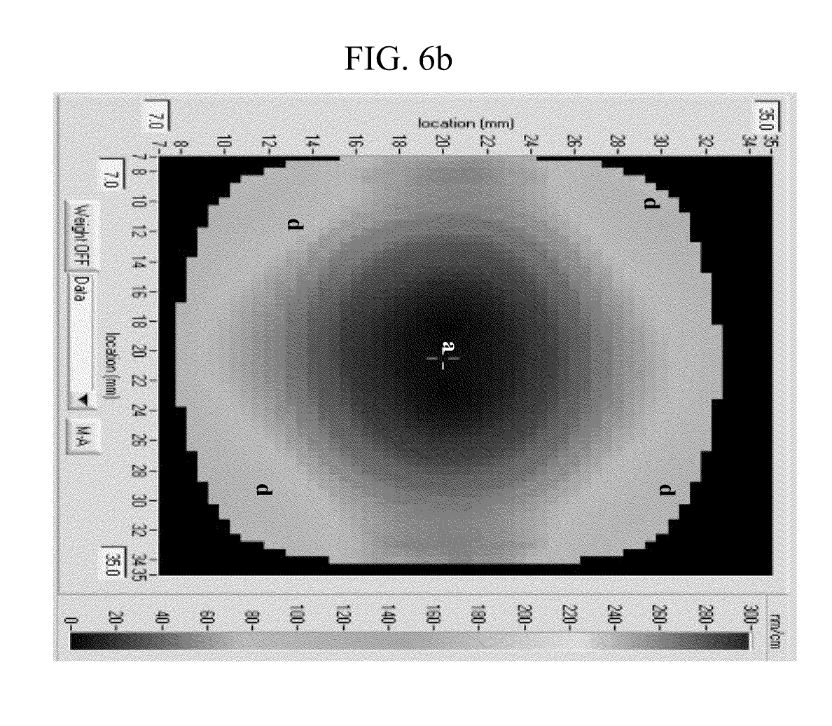

Birefringence images of a polygonal “pillow” window before and after annealing are shown in FIGS. 6a and 6b, respectively. Prior to annealing (FIG. 6a, the window exhibits more homogenous levels of birefringence than a rectangular window (FIG. 5), with a region of low (a) birefringence surrounded by a region having medium (c) birefringence. After annealing (FIG. 6b), the overall level of birefringence in the window is reduced by about 50%, with an expanded region having low (a) birefringence and regions (d) having medium-low levels of birefringence. The birefringence patterns of the unannealed and annealed polygonal “pillow” window are more symmetric than the birefringence patterns exhibited by the unannealed and annealed rectangular window shown in FIG. 5.

Frame 220 can have the same geometry/symmetry as both the window and the interface. In FIGS. 2a and 2b, frame 220 is also circularly symmetric about single point p. The optical window assembly 200 shown in FIGS. 2a-b comprises a disc-shaped transparent window 210 affixed inside a ring-shaped protective housing or frame 220 and has a circular geometry about point p in plane a. It is not necessary, however, that the frame has the same geometry and/or symmetry as the interface and window. For example, if the frame is sufficiently stiff so as not to induce non-circular stress at the interface or in the window, the frame can have a square, rectangular, or other polygonal shape having a geometry/symmetry that differs from that of the interface and window. One such frame is schematically shown in FIG. 2d. Here, frame 220 has an octagonal shape while both interface 225 and window 210 have a circular symmetry about point p. Although frame 220 in FIG. 2d still stresses the glass window 210 at interface 225, the stress induced in window 210 will be circularly symmetric. Due to this circular symmetry, the induced birefringence in window 210 will cancel out and the net birefringence may be less than 2 nm/cm if the entire assembly is precision annealed after sealing.

In some embodiments, window 210 is hermetically sealed to frame 220 at interface 225 by those means known in the art. In some embodiments, optical window 200 further includes an opaque coating 230 disposed on either an upper or lower surface of window 210. Opaque coating 230 defines a transparent aperture 215 through which light 250 can pass. Light 250 can pass through transparent aperture 215 and either strike a mirror or mirror array (not shown) and be reflected back out through aperture 215 after striking such mirrors or mirror arrays. Optical window assembly 200 can also optionally include an anti-reflective coating or film disposed on at least one of the top and bottom surfaces of transparent window 210.

Window 210 is, in some embodiments, a planar sheet of glass or glass ceramic materials that is transmissive to electromagnetic radiation in all or part of the visible portion of the spectrum. In some embodiments, transparent window 210 is formed from a material having a low coefficient of thermal expansion (CTE) such as, but not limited to, borosilicate glasses, alkali borosilicate glasses (e.g., KOVAR™ sealing glass 7056, manufactured by Corning, Inc.), and other transmissive glass materials known in the art. Window 210 is typically ground, lapped, and polished.

Housing or frame 220 typically comprises a metal or alloy. In some embodiments, it is desirable that frame 220 have a coefficient of thermal expansion that closely matches or approximates that of transparent window 210. Accordingly, frame 220 can comprise such alloys that are known in the art to have CTEs that are comparable to the thermal expansion characteristics of materials that comprise transparent window 210. Non-limiting examples of such alloys include nickel-cobalt ferrous alloys (e.g., KOVAR), nickel-iron alloys (e.g., INVAR™), steels, or the like.

In some embodiments, window 210 is hermetically sealed and/or affixed to frame 220 at interface 225 by forming a glass-to-metal seal between transparent window 210 and frame 220. In some instances, the glass-to-metal seal is a matched seal, in which the CTEs of the frame and window materials are matched to reduce stress in or at interface 225. A matched seal is chemical, with the glass reacting with oxidized metal and/or alloy on the surface of the frame. A matched seal, for example, is formed between a Corning 7056 glass window and a KOVAR alloy frame, as described hereinbelow. In those embodiments in which the metal or alloy frame has a higher metal expansion than the glass window, the glass-to-metal seal is a compression seal. The bond between the window and frame materials in a compression seal is both mechanical and chemical. Compression sealing is prevalent in those instances where the frame is formed from steel or Fe—Ni binary alloys and glasses such as barium alkali glasses.

In one particular embodiment, window 210 is formed from an alkali borosilicate glass (Corning 7056 glass; composition: 35 wt % SiO₂; 10 wt % K₂O; 2% Al₂O₃; 1 wt % Na₂O; 1 wt % Li₂O; <1 wt % Sb₂O₃; and <1 wt % As₂O₃), and frame 220 is formed from KOVAR (Fe-29Ni-17Co) alloy. The CTE of KOVAR alloy closely—but not exactly—matches that of borosilicate glasses, such as 7056 glass. A glass-to-metal seal is formed between the KOVAR frame material and the 7056 glass by first wet etching the KOVAR with acid to increase the surface area of the bond between the alloy frame and glass window. The KOVAR alloy frame is then carburized at 900° C.-1000° C. to remove any residual carbon from the frame, after which the frame is oxidized at 800° C.-1100° C. The oxidation step is necessary, as the glass window bonds only to the oxide layer formed on the alloy frame. After oxidation of the frame, the glass window is sealed to the frame at 900° C.-1000° C. in a nitrogen atmosphere, and the sealed part is cooled at a slow rate to about 500° C. to reduce stresses in the glass interface/joint.

In other embodiments, window 210 is hermetically sealed and/or affixed to frame 220 at interface 225 by those means known in the art, such as adhesives and/or sealing agents. Non-limiting examples of such adhesives and sealing agents are described in U.S. Pat. No. 7,348,193, by Mike Xu Ouyang et al., entitled “Hermetic Seals for Micro-Electromechanical System Devices,” issued on Mar. 25, 2008, the content of which is incorporated by reference in its entirety.

Opaque coating 230 can comprise those materials known in the art, such as multilayer chromium/chromium oxide (Cr/CrOₓ) coatings, which are deposited by those means known in the art such as, for example, physical vapor deposition (PVD) techniques, including ion-assisted electron beam evaporation. Non-limiting examples of opaque coatings are described in U.S. Pat. No. 7,160,628, by Robert Bellman et al., entitled “Opaque Chrome Coating Having Increased Resistance to Pinhole Formation,” issued on Jan. 9, 2007, the content of which is incorporated by reference in its entirety. Non-limiting examples of anti-reflective coatings are described in U.S. Patent Application Publication 2006/0139757 A1, by Michael D. Harris et al., entitled “Anti-Reflective Coating for Optical Windows and Elements,” filed on Oct. 28, 2005, the content of which is incorporated by reference in its entirety.

As previously described herein, current optical windows 110 (FIG. 1a) have both a shape and a clear or transparent aperture 115 that mirrors or corresponds to the aspect ratios of typical image formats used in digital light processing applications. Window 210 is sized such that transparent aperture 215 is sufficiently large so as to provide an image aperture that has an aspect ratio that mirrors or corresponds to the aspect ratio of a projected rectangular image format. In one embodiment, transparent aperture 215 has an area of up to about 1300 mm².

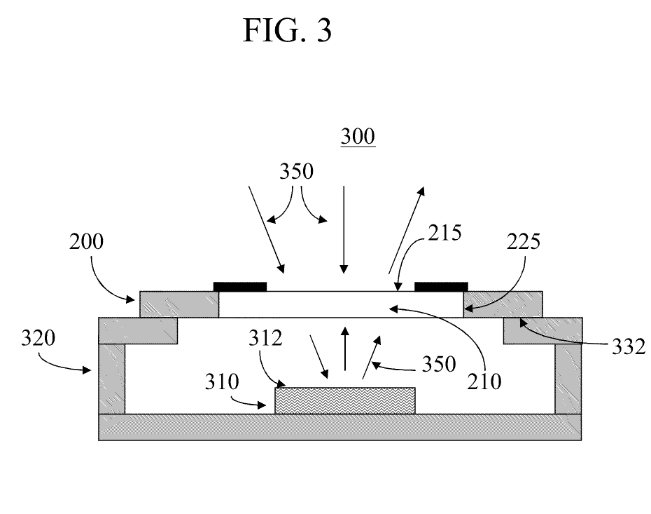

In one embodiment, the optical window assembly 200 having a geometry that minimizes retardance and residual or net induced birefringence as described herein is used in devices such as optical, micro-electromechanical, electronic, and opto-electronic devices having at least one optical, micro-electromechanical, electronic, or opto-electronic element. Non-limiting examples of such devices include digital light processing (DLP™) or digital micro-mirror (DMD) devices. Accordingly, such a device comprising the optical window assembly described herein is provided. A cross-sectional schematic view of such a device is shown in FIG. 3. Device 300 comprises at least one optical element 310 enclosed in a housing 320. Optical element 310 has an optically active surface 312, such as, for example, a mirror face. In those instances where device 300 is a DLP or DMD, optical element 310 can be a mirror or an array of mirrors that are typically rectangular in shape. Housing 320 includes an optical window assembly 330, such as those described hereinabove, affixed to housing 320 so as to define an enclosure 325. In some embodiments, optical window assembly 200, described herein, is hermetically sealed to housing 320 at interface 332. Transparent aperture 215 of optical window assembly 200 is optically aligned with optically active surface 312 of optical element 310 and thus allows light 350 to enter housing 320 to strike and interact with optically active surface 312 of optical element 310. Aperture 215 also allows light 350 to exit housing 320 after being reflected by optically active surface 312 of optical element 310.

Optical window assembly 200 pictured in FIG. 3 has a geometry, such as those described hereinabove, that either minimizes net induced birefringence within optical window assembly 200 or provides a zero net induced birefringence in optical window assembly 330. The geometry of optical window assembly 200 and, in particular, interface 225 and window 210 creates a retardance δ in the transparent aperture 215 of window 210 that is less than 2 nm when sealing of the glass is followed by precision annealing of the entire assembly. In some embodiments, both the retardance δ and the net induced birefringence of window 210 are reduced to a minimum value or are equal to zero. In some embodiments, the geometry of optical window assembly 200 and, in particular, interface 225, and window 210 are circularly symmetric about a single point.

The residual induced birefringence in windows within an optical train can be reduced by changing to oversize optical window assembly 200 having a stress-reducing geometry, as described herein, which provides a sufficiently large aperture 215 to accommodate a rectangular mirror array. In MEMS-based three dimensional projector applications, such low birefringence optical window assemblies 200 described herein maintain the desired polarization state of the projected light. Consequently, less light is lost due to polarization and the need for positioning polarizers at or near the end of the optical train to ‘clean up’ or correct the polarization state of light passing through the train is reduced or eliminated.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. An optical window assembly comprising a window affixed to a frame at an interface, the window having a transparent aperture, and wherein the interface has a geometry such that retardance of the window within the transparent aperture is less than 2 nm.

2. The optical window assembly of claim 1, wherein the geometry has a circular symmetry.

3. The optical window assembly of claim 1, wherein the window has a circular symmetry.

4. The optical window assembly of claim 3, wherein the frame has a circular symmetry, and wherein the window and the frame are circularly symmetric about a single point.

5. The optical window assembly of claim 3, wherein the window is a round glass disk.

6. The optical window assembly of claim 4, wherein the frame is a ring-shaped frame comprising at least one of an alloy and a metal.

7. The optical window assembly of claim 1, wherein the window has a net induced birefringence equal to zero.

8. The optical window assembly of claim 1, wherein the optical window assembly forms a portion of a device having at least one of an optical element, a micro-electromechanical element, and an opto-electronic element.

9. The optical window assembly of claim 8, wherein the device is a micro electro-mechanical system.

10. The optical window assembly of claim 1, wherein the transparent aperture is at least as large as an image aperture, the image aperture having aspect ratio corresponding to a projected image format.

11. The optical window assembly of claim 1, wherein the transparent aperture has an area of up to 1300 mm².

12. The optical window assembly of claim 1, wherein the window comprises one of a borosilicate glass, an alkali borosilicate glass, silica glass, and a glass ceramic.

13. The optical window assembly of claim 1, wherein the frame comprises at least one of a nickel-cobalt ferrous alloy, a nickel-iron alloy, steel, and combinations thereof.

14. The optical window assembly of claim 1, wherein the window is hermetically sealed to the frame at the interface.

15. The optical window assembly of claim 1, wherein the frame has the same geometry as the interface.

16. An optical window assembly, the optical window assembly comprising:
a. a circularly symmetric window having a transparent aperture; and
b. a frame, wherein the circularly symmetric window is affixed to the frame, wherein the circularly symmetric window has a retardance of less than 2 nm within the transparent aperture.

17. The optical window assembly of claim 16, wherein the net birefringence is zero.

18. The optical window assembly of claim 16, wherein the frame is circularly symmetric and wherein the window and the frame are circularly symmetric about a single point.

19. The optical window assembly of claim 18, wherein the window is a circular glass disk and wherein the frame is a ring-shaped frame comprising at least one of a metal and an alloy.

20. The optical window assembly of claim 16, wherein the circularly symmetric window comprises one of a borosilicate glass, an alkali borosilicate glass, silica glass, and a glass ceramic.

21. The optical window assembly of claim 16, wherein the frame comprises at least one of a nickel-cobalt ferrous alloy, a nickel-iron alloy, steel, and combinations thereof.

22. The optical window assembly of claim 16, wherein the transparent aperture is at least as large as an image aperture, the image aperture having aspect ratio corresponding to a projected image format.

23. The optical window assembly of claim 16, wherein the transparent aperture has an area of up to 1300 mm².

24. The optical window assembly of claim 16, wherein the optical window assembly forms a portion of a device having at least one of an optical element, a micro-electromechanical element, and an opto-electronic element.

25. The optical window assembly of claim 24, wherein the device is a micro electro-mechanical system.

26. The optical window assembly of claim 16, wherein the window is hermetically sealed to the frame.

27. An opto-electronic device, the opto-electronic device comprising:
a. a housing;
b. an optical window assembly affixed to the housing so as too define an enclosure, the optical window assembly comprising a window affixed to a frame at an interface, the window having a transparent aperture, and wherein the interface has a geometry such that retardance of the window within the transparent aperture is less than 2 nm; and
c. an optical element disposed within the enclosure such that an active portion of the optical element is optically aligned with the transparent aperture.

28. The opto-electronic device of claim 27, wherein the enclosure is hermetically sealed.

29. The opto-electronic device of claim 27, wherein the geometry of the interface has a circular symmetry.

30. The opto-electronic device of claim 29, wherein each of the window and the frame are circularly symmetric about a single point.

31. The opto-electronic device of claim 30, wherein the window is a circular glass disk and wherein the frame is a ring-shaped frame comprising at least one of a metal and an alloy.
